(19) United States
(12) Patent Application Publication
(10) Pub. No.: US 2012/0151535 A1
(43) Pub. Date: Jun. 14, 2012

(54) Internet television system

(76) Inventor: Pradeep Ramdeo, Bronx, NY (US)

(21) Appl. No.: 13/373,815

(22) Filed: Dec. 1, 2011

Related U.S. Application Data
(60) Provisional application No. 61/458,816, filed on Dec. 2, 2010.

(51) Int. Cl. H04N 21/47

(52) U.S. Cl. 725/62; 725/110

(57) ABSTRACT

A television system for accessing the interne through a television is provided. The television has a display screen. The television system comprises a wireless internet receiver and/or transmitter mounted within the television wherein the internet receiver and transmitter allow a user to access the internet through the television.

### INTERNET TELEVISION SYSTEM

The present application claims the benefit of priority of pending provisional patent application Ser. No. 61/458,816, filed on Dec. 2, 2010, entitled “Internet Television”.

### BACKGROUND OF THE INVENTION

1. Field of the Invention

This invention relates generally to an internet television system and, more particularly, the invention relates to an internet television system which equips a television, such as a high-end, contemporary large flat screen television, with plasma, LCD (Liquid Crystal Display) screen, and/or latest screen technology, with a wireless WIFI and/or other receiver and/or transmitter, a wireless keyboard with a mouse, and other components, functions, features of a high-end PC.

2. Description of the Prior Art

Combining aspects of two technologies common to virtually all American homes is important. Especially, it would be desirable to combine the television and the Internet-capable computer. Considered separately, both television and the personal computer have revolutionized lives and refinements in these technologies such as large, flat screen televisions and wireless Internet continue to do so.

### SUMMARY

The present invention is a television system for accessing the internet through a television. The television has a display screen. The television system comprises a wireless internet receiver and/or transmitter mounted within the television wherein the internet receiver and transmitter allow a user to access the internet through the television.

In addition, the present invention includes a television system for accessing the internet through a television. The television has a display screen. The television system comprises a wireless internet receiver and/or transmitter mounted within the television and software for an internet browser and an e-mail program. The internet receiver and transmitter allow a user to access the internet through the television. The internet may be displayed on a portion of the display screen of the television with a television program being displayed on another portion of the display screen.

The present invention further includes a method for accessing the internet through a television. The television has a display screen. The method comprises mounting a wireless internet receiver and/or transmitter within the television and accessing the internet through the television.

### BRIEF DESCRIPTION OF THE DRAWINGS

FIG. 1 is a perspective view illustrating an internet television system, constructed in accordance with the present invention.

### DETAILED DESCRIPTION OF THE PREFERRED EMBODIMENTS

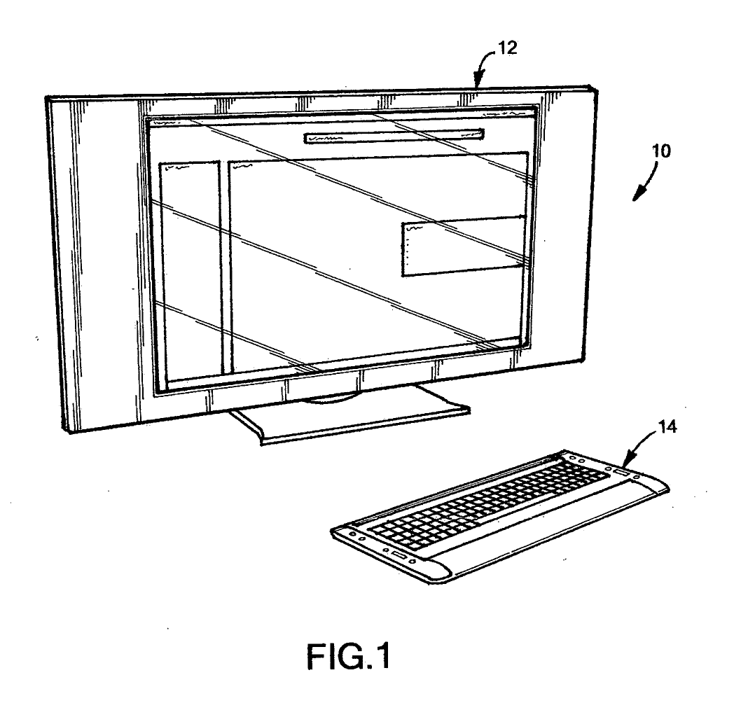

As illustrated in FIG. 1, the present invention is an internet television system, indicated generally at 10, for equipping a high-end various size contemporary large flat screen television 12, with plasma LCD (Liquid Crystal Display) screen, or the latest screen technology, with a wireless Internet receiver and/or transmitter, a wireless keyboard 14, and the other components, functions, and features of a high-end computer such as processor, operating system, memory and the like. Enclosed herewith are four (4) sheets of Exhibit A hereby herein incorporated by reference.

The internet television system 10 of the present invention equips a premium-quality flat screen television 12 with a wireless Internet receiver and/or transmitter that may function like a wireless router as well as a wireless keyboard 14, and the software for an Internet browser, e-mail program, and other desired softwares or applications services or functions. The internet television system 10 expands the television's functions to include that of a large, high-definition computer monitor. Various models can have various sizes, components, and features. The internet television system 10 can be equipped to work in conjunction with a wireless Internet router and/or with Wi-Fi networks, cellular/satellite internet or other types of internet. Screen options on the television 12 enable the user to view television 12 and video at full-screen, to view the Internet (and downloaded content from the Internet) at full-screen; and split-window or multiple windows at the same time functions allow viewers to enjoy television and Internet windows simultaneously. The internet television system 10 will have wireless compatibility with other household wireless devices such as smart-phones and PDAs, a personal computer, printers, and so forth, so that content can be shared or downloaded to or from these devices to the internet television 12. Further, multiple internet television systems 10 installed in the home can link wirelessly with one another, as multiple laptops can share the same wireless router signal.

Various models of the internet television system 10 of the present invention may also be equipped with its own CD/DVD burner to download and copy discs from either the television or the Internet. Some internet television systems 10 may also include a built-in modem and an SD (Secure Data) card slot and/or USB or other ports to accommodate data downloaded or file transfer to or from a computer to the television 12. Given the compact size of contemporary laptops, tablets, and netbooks, it is within the capabilities of existing technology to incorporate a fully or partial components and features of the computer into the internet television system 10, thus producing a truly and uniquely all-in-one system.

The internet television system 10 of the present invention, a home-entertainment, information, and communications system combining a large flat screen, plasma, LCD, or other television 12 with wireless Internet capability, presents users with tremendous convenience and versatility. The internet television system 10, by combining the functions of television and Internet browser, enables users to watch a movie on one window, for example, and use the Internet to identify the stars, location, and read the movie's reviews on another. Users can use their internet television system 10 to download video, watch television, listen to internet radio, and other programming from the Internet, and with the click of a mouse or a stroke or two on the wireless keyboard 14, immediately be enjoying that content on a big, flat screen, high-definition television 12. Further, because the internet television system 10 has been designed to communicate wirelessly with a variety of other wireless devices, and with other internet television systems 10 in the house, the internet television system 10 is far more than an appliance; it is a system 10 of multi-modal wireless communications. Equally useful to those who enjoy television, movies, video games, and other offerings associated with television, and those who prefer the on-line world of the Internet, the internet television system 10 meets all the electronic entertainment/information needs of the contemporary household in a single device.

Various models of the internet television system 10 of the present invention can also be made for commercial use as display boards and can be used in hotels, hospitals, restaurants, airports, or other public places, both inside and outside. Some models of the internet television system 10 can also be made to be controlled by voice using voice applications. For example, some models of the internet television system 10 may have a personal assistant that the user can communicate with.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein may be suitably practiced in the absence of the specific elements which are disclosed herein.

What is claimed is:

1. A television system for accessing the internet through a television, the television having a display screen, the television system comprising:
a wireless internet receiver and/or transmitter mounted within the television;
wherein the internet receiver and transmitter allow a user to access the internet through the television.

2. The television system of claim 1 and further comprising:
a wireless keyboard for interacting with the internet receiver and transmitter.

3. The television system of claim 1 and further comprising:
software for an internet browser and an e-mail program.

4. The television system of claim 1 wherein the internet receiver and transmitter operates in conjunction with a wireless Internet router and with Wi-Fi networks, cellular/satellite internet, and other types of Internet.

5. The television system of claim 1 wherein the internet is displayed on the entire display screen of the television.

6. The television system of claim 1, wherein the internet is displayed on only a portion of the display screen of the television, a television program being displayed on another portion of the display screen.

7. The television system of claim 6 wherein the display screen may be split equally in half, either horizontally or vertically, with the internet displayed on one half and the

8. The television system of claim 1 wherein the internet syncs with smart cellular telephones and PDAs, a personal computer, and printers.

9. The television system of claim 1 and further comprising:
multiple television systems wirelessly interacting with each other.

10. The television system of claim 1 and further comprising:
a CD/DVD burner mounted within the television.

11. The television system of claim 1 and further comprising:
a modem mounted within the television.

12. The television system of claim 1 and further comprising:
an SD (Secure Data) card slot formed in the television.

13. The television system of claim 1 and further comprising:
at least one data port.

14. The internet television system of claim 1 and further comprising:
voice control of the internet and television.

15. A television system for accessing the internet through a television, the television having a display screen, the television system comprising:
a wireless internet receiver and/or transmitter mounted within the television; and
software for an internet browser and an e-mail program;
wherein the internet receiver and transmitter allows a user to access the internet through the television; and
wherein the internet is displayed on only a portion of the display screen of the television, a television program being displayed on another portion of the display screen.

16. The television system of claim 15 and further comprising:
a wireless keyboard for interacting with the internet receiver and transmitter.

17. The television system of claim 15 wherein the internet receiver and transmitter operates in conjunction with a wireless Internet router and with Wi-Fi networks, cellular/satellite internet, and other types of Internet.

18. The television system of claim 15 wherein the display screen is split equally in half, either horizontally or vertically, with the internet displayed on one half and the television program being displayed on the other half of the display screen, simultaneously.

19. The television system of claim 15 and further comprising:
a CD/DVD burner mounted within the television.

20. A method for accessing the internet through a television, the television having a display screen, the method comprising:
mounting a wireless internet receiver and/or transmitter within the television; and
accessing the internet through the television.
